(19) United States
(12) Patent Application Publication
(10) Pub. No.: US 2002/0161682 A1
(43) Pub. Date: Oct. 31, 2002

(54) Computerized system and method used in financial and retirement planning

(76) Inventors: Anton A. Ewing, Phoenix, AZ (US); William Everts, Phoenix, AZ (US)

Correspondence Address: Kenneth H. Tarbet, Suite 100, 11201 N. Tatum Blvd., Phoenix, AZ, 85028, US

(21) Appl. No.: 09/793,450

(22) Filed: Feb. 27, 2001

(51) Int. Cl. G06F 17/60

(52) U.S. Cl. 705/36

(57) ABSTRACT

This invention is directed to a computer-implementable process for calculating financial retirement needs or whether a future financial needcan be met based on current financial vehicles, through the use of multiple categories or classes of assets. The main reason that different categories or classes of assets are employ is due to different treatments of each class or financial vehicle under the US Tax Code.

### FIELD OF INVENTION

The present invention is directed to a computer implemented system and method used in the field of financial planning. More specifically, the present invention is directed to a computerized tool used in retirement planning that produces estimated values of needed savings levels so as to produce or otherwise provide future income based on certain economic assumptions and data regarding an individual subject's current financial status. The present invention further distributes assets during this analysis first from taxed accounts before tax-deferred accounts and/or tax free accounts successively depleting an account before distributing assets from one higher on the investment productivity scale.

### BACKGROUND OF THE INVENTION

Recent studies have shown that many people will not have saved the amount of money needed for their retirement. According to one recent study on potential shortfalls in retirement income, nearly eight out of ten households will probably have less than half of what they need to retire comfortably. Many people find saving difficult, especially when it comes to knowing how much to save. People planning for retirement often need help in answering a number of questions, such as, for example: how many years do I need to plan for, what is the best age to retire, what if I work longer, how much money will I need when I retire, what if I save more today, what if I adjust my standard of living after I retire, how much should I be saving? Computer systems exist that can assist in some areas relating to retirement planning. In general, these computer systems are either non-interactive and do not provide alternative strategies tailored to the user's situation or are too flexible and do not provide the guidance that most users require. For example, some software used in retirement planning allows the user to enter the appropriate information (e.g., user's age, current income, assets, retirement goal) and the software will inform the user whether or not the user's goal has been met. If the user has not met his or her goal, the program may output a general list of things the user can do to possibly reach that goal, e.g., save more now, change investments, retire later, work part-time. However, the alternative strategies presented to the user are general, not tailored to the user's situation and do not take into account the user's preferences. Usually, there is no suggestion provided as to which alternative strategy would be the one that the user would most likely find of interest. Nor do such programs provide details (such as, for example, number of years for which income is needed, average income) of any alternative retirement strategy. Thus, these programs do not make suggestions as to how factors can be varied to more closely obtain the desired retirement goal or provide details of how the user's retirement goal could be varied to obtain other desirable retirement strategies. Typically, if the user wishes to explore an alternative strategy, the user is required to guess what would be the most desirable factor to change, re-enter the new input and have the program again perform the calculation. Such systems are not efficient, particularly where the user does not have access to a computer and the information is collected from the user and processed in a batch process.

In financial planning, a time horizon or investment horizon refers to the time frame in which an individual will be investing. It is a generally accepted principle that investments used for fulfilling near-term financial objectives should be more conservative than investments used for fulfilling long-term financial objectives. The basis for this investment strategy is that a longer time horizon provides sufficient time to ride out the market's periodic swings. Suppose, for example, that an individual wishes to save money for a single financial event expected to occur at a specific point in time, a trip to Europe in 25 years. The initial time horizon is 25 years. However, as the years pass, the time horizon decreases, so in five years, the event will be 20 years away, and in 10 years, the event will be 15 years away, and so on. As the time horizon of the event changes, so should the investment of the funds being saved for the event. Therefore, what may start out to be a long term, fairly aggressive investment strategy where a large amount of money is being invested in stocks should gradually become a short-term, fairly conservative investment strategy where a large amount of money is being invested in short-term reserves. However, the exact mix of asset classes that are invested in depends on the individual's attitude toward risk. Stocks are more risky assets with a higher expected return and short-term reserves are less risky with a lower expected rate of return. As the mix of asset classes change, the overall expected rate of return will decrease. Therefore, it is unreasonable to assume a constant, fixed rate of return over the life of an investment, when that investment is planned for attaining a specific future objective. While it is common to state the general relevance of time horizon when introducing an individual to the principles of investing, no attempt is usually made to take into account the effect of a changing time horizon when estimating the rate at which savings should be invested in ordering to prepare for future expenditures associated with fulfilling future financial objectives. Currently available financial models aimed at assisting individuals in making reasonable financial investment decisions focus on the individual's attitude towards risk or risk aversion. The time horizon of the individual is often treated as a secondary consideration and captured as a single value (i.e., the average time horizon at the present time). This single value is then used in various ways along with the individual's risk attitude to help the investor identify a portfolio comprising of a mix of asset classes appropriate for attaining the future financial objectives. In other approaches, the mix of asset classes is used along with historical market data to determine what rate of return the portfolio of asset classes would have attained in the given historical setting. Market forecasting is then used to identify an expected rate of return for the given portfolio, which is generally assumed to be constant. The rate of return is then used to determine the rate of savings (i.e., weekly, monthly, yearly, etc.) required at the assumed rate, assuming inflation and taxes, in ordering to achieve a future value sufficient for the expected cost of one or more financial objectives. Since the currently available financial models do not accurately take into account the effect of a changing time horizon, the generated expected rate of return will not be correct since it will be assumed to be constant throughout. This prevents the individual from achieving a future value sufficient to fulfill their desired financial objectives. Therefore, there is a need for a method of developing a financial model that takes into account the accepted desire to spend or use money from the least productive investment and/or financial vehicle until depleted, before accessing other more productive classes of assets. Through the implementation of this ordering of investment vehicles in a consistent manner, an individual would be able to achieve a future value sufficient for the expected costs of fulfilling one or more financial objectives.

Other software programs used in retirement planning could be regarded as totally interactive. For example, in such programs, users can enter and modify all or most parameters and assumptions to obtain the results desired. The disadvantage of such programs is that the user may not be given enough guidance in those areas where the user is likely to have no expertise, such as, for example, rate of return, inflation, earnings growth rate, number of retirement years for which income is needed, and amount of retirement income needed each year, etc. It is not advantageous to allow users to specify or change the parameters or assumptions used by the program when the user is not an expert in such areas and, further, may not be given enough guidance by the program in the best combinations of parameters or assumptions to be used in the user's particular case and for a specific retirement scenario.

Thus, there exists a need for a system used in retirement planning and for planning for a future financial need, that classifies assets according to defined financial vehicle criteria, wherein lower yield and tax benefit investments are depleted before, higher yield financial vehicles, and where the financial vehicles providing the greatest benefit are depleted only after other classes of assets are empty or insufficient to accomplish the desired financial goal.

### SUMMARY OF THE INVENTION

This invention is directed to a computer-implementable process for calculating financial retirement needs based upon the theory or use of multiple categories or classes of assets. The main reason that different categories or classes of assets are employ is due to different mathematical treatments under the US Tax Code. The computer program's theory of calculation, using more than one asset class, is such that a retiree will not fully deplete his or her asset base before he or she is deceased. Stated differently, the program never inquires as to when a person is going to die. The program treats each retirement asset class differently based upon user selectable and predefined ordering criteria.

### DETAILED DESCRIPTION OF THE INVENTION

A computer-implementable process for evaluating a financial plan comprising:

a first variable adapted to represent financial data;

a second variable adapted to represent financial data; and

a third variable adapted to represent financial data wherein;

the third variable represents a financial goal, at a future time, the first variable represents a first array and the second variable represents a second array wherein;

the first array contains a list of assets and the second array contains a list of investment vehicles, and wherein;

the second array is selectably ordered according to a second ordering criteria, and wherein;

the first array is selectably ordered according to a first ordering criteria.

The ordering criteria may be stored in variables of any type, such as array, character, float or other variable type as is known in the art. The relative ordering of investment vehicles stored within the ordering criteria data-set may be statically entered into the computer code or may be a matter of input by a user. Where the ordering is selected by a user, the user may define and ordering specific investment vehicles in a custom order, which may not be in harmony with accepted investment and/or accounting and/or wealth management practices known in the art. The financial goal will typically involve a desired income stream after retirement, but may also be the acquisition of a capital asset, such as a boat, and may further be the future acquisition of substantial expense such as educational expenses, wedding expenses or down payment for children's first house. Regardless of the financial goal and the future time for its need, the present invention provides a computer-implementable method whereby a set of ordering criteria are used to analyze a proposed set of investment vehicles, as seen through an ordering algorithm displays the financial result of the input criteria, over the period until the future time event. This analysis is presented to the user both graphically and numerically. The result of this analysis may be printed and fixed in a tangible medium of expression. The present invention provides for user definable and user manipulable ordering criteria whereby the users observe the results of different financial strategies. Although the program attempts to instruct the user in the proper, or recommended ordering criteria for fund depletion, the user has control.

### EXAMPLES

The following examples are provided to assist one of skill in the art to practice the invention and do not limit the scope of the invention, which is limited only by the appended claims.

### Example 1

A man having an IRA and a bank-based savings account wants to analyze a retirement scenario. A computer program according to one embodiment of the present invention having the first variable contain ordering information based on the current IRS Code and the second variable contain the investment vehicles used by this man. The ordering criteria dictates that the savings account is seen as the lowest financial vehicle class, and should be depleted before other financial vehicles. Through this scenario, the savings account would be emptied of money before taking any withdrawals from the IRA account.

### Example 2

Anton's Current Age: 30

Years Until Desired Retirement: 20 Years

Total Annual Contributions to All Retirement Investments: $18,000

Retirement Age: 50

Assumed Annual Rate of Inflation: 4%

Assumed Annual Rate of Return on All Investments: 12%

Total Current Combined Annual Salary: $95,000

First Year of Retirement

| | |
|---|---|
| Standard of Living Adjusted for Inflation: | $150,248 |
| Projected Taxable Brokerage Account Balance: | $568,782 |
| Projected Qualified Accounts Balance: | $1,113,079 |
| Projected Tax Free Accounts Balance: | $455,000 |

Taxable Brokerage Account Money is projected to be depleted
when you are age: 57

Beginning of Qualified Money Distribution

| | |
|---|---|
| Standard of Living Adjusted for Inflation: | $194,467 |
| Projected Qualified Accounts Balance: | $2,345,621 |
| Projected Tax Free Accounts Balance: | $373,337 |

Qualified Money is projected to be depleted when you are age: 87

Beginning of Tax Free Money

| | |
|---|---|
| Standard of Living Adjusted for Inflation: | $425,140 |
| Projected Tax Free Accounts Balance: | $11,216,357 |

Congratulations. Your Tax Free Money Exceeds You Standard of Living Requirements.

These examples demonstrate the use of the criteria whereby the least financially beneficial vehicles are depleted before any other assets are used.

1. A computer-implementable process for evaluating a financial plan comprising:
a first variable adapted to represent financial data;
a second variable adapted to represent financial data; and
a third variable adapted to represent financial data wherein;
the third variable represents a financial goal, for a future time, the first variable represents a first array and the second variable represents a second array wherein;
the first array contains a list of assets and the second array contains a list of investment vehicles, and wherein;
the second array is selectably ordered according to a second ordering criteria, and wherein;
the first array is selectably ordered according to a first ordering criteria.

2. The computer-implementable process according to claim 1 wherein the first ordering criteria is defined by a user input so as to contain user specific assets.

3. The computer-implementable process according to claim 1 wherein the second ordering criteria is a predefined order.

4. The computer-implementable process according to claim 3 wherein the predefined ordering is derived from accepted accounting practices.

5. The computer-implementable process according to claim 3 wherein the predefined ordering is derived from accepted wealth-management practices.

6. The computer-implementable process according to claim 5 wherein the predefined ordering is a priority ordering for depletion.

7. The computer-implementable process according to claim 6 wherein the priority ordering results in a growth and income efficiency.
